(19) United States
(12) Patent Application Publication
(10) Pub. No.: US 2004/0121638 A1
(43) Pub. Date: Jun. 24, 2004

(54) Sealing plug and a watertight connector provided therewith

(75) Inventor: Tomohiko Kobayashi, Yokkaichi-City (JP)

Correspondence Address: CASELLA & HESPOS, 274 MADISON AVENUE, NEW YORK, NY, 10016

(73) Assignee: Sumitomo Wiring Systems, Ltd., Yokkaichi-City (JP)

(21) Appl. No.: 10/730,827

(22) Filed: Dec. 8, 2003

(30) Foreign Application Priority Data
Dec. 18, 2002 (JP) 2002-366753

(51) Int. Cl. H01R 13/52

(52) U.S. Cl. 439/274

(57) ABSTRACT

A rubber plug (10) is inserted into a cavity (21) of a connector housing (20) after an insulated wire (40) is inserted through a wire insertion hole (11) to provide a watertight seal between an inner wall of the cavity (24) and the insulated wire (40). Frictional resistance between the inner wall of the cavity (24) and the rubber plug (10) is larger than the frictional resistance between the insulated wire (40) and the rubber plug (10). The frictional resistance between the insulated wire (40) and the rubber plug (10) permits movement of the insulated wire (40) relative to the rubber plug (10) when the insulated wire (40) is caused to expand in longitudinal direction by heat.

### BACKGROUND OF THE INVENTION

1. Field of the Invention

The invention relates to a sealing plug to be used in a watertight connector and to a watertight connector provided with such sealing plug.

2. Description of the Related Art

Japanese Unexamined Utility Model Publication No. S63-3074 and FIG. 6 herein disclose a rubber plug used in a watertight connector. With reference to FIG. 6, the rubber plug 1 closely holds an insulated wire 2 inserted therethrough. The watertight connector includes a housing 3 with a rear surface and a cavity 4 that extends into the rear surface. The plug 1 is insertable into the cavity 4. The plug 1 is formed with a plurality of outer rips 5 that can be brought into close contact with the inner wall of the cavity 4. The rubber plug 1 is fixed to a terminal fitting 6 by crimping a barrel 7 of the terminal fitting 6 to the front end of the rubber plug 1. The terminal fitting 6 is inserted into the cavity 4 and held in position by a resiliently deformable lock 8 formed in the cavity 4. As a result, the rubber plug 1 engages the inside of the cavity in a watertight manner.

The insulated wire 2 may be displaced backward in the cavity 4 by the repeated expansion and elongation of a covering resin of the insulated wire 2 in a heat-cycle environment. The rubber plug 1 is mounted closely on the insulated wire 2 and may be displaced back in the cavity 4 with the insulated wire 2. Thus, some of the outer lips may come out of the cavity 4 to impair a sealing property.

The invention was developed in view of the above problem and an object thereof is to maintain the sealing property of a sealing plug.

### SUMMARY OF THE INVENTION

The invention relates to a sealing plug for a watertight connector. The sealing plug has at least one wire insertion hole through which a wire is to be inserted. Additionally, the sealing plug is insertable into a cavity of a connector housing to provide watertight sealing between the inner wall of the cavity and the wire. Frictional resistance between the inner wall of the cavity and the sealing plug is set larger than the frictional resistance between the wire and the sealing plug. Additionally, the frictional resistance between the wire and the sealing plug is set to permit movement of the wire relative to the sealing plug when the wire is moved, such as when the wire expands and elongates longitudinally due to heat. As a result, movement of the sealing plug relative to the cavity in response to movement of the wire can be suppressed. Thus, the sealing plug is prevented from coming out, thereby maintaining good sealing.

At least one outer lip preferably is formed on the outer surface of the sealing plug for closely contacting the inner wall of the cavity, and at least one inner lip preferably is formed on the inner circumferential surface of the sealing plug for closely contacting the wire. A degree of deformation of the outer lip preferably is larger than a degree of deformation of the inner lip. As a result, a larger frictional resistance can be obtained between the outer lip and the inner wall of the cavity.

The number of outer lips may exceed the number of inner lips so that the total frictional resistance between the inner wall of the cavity and the outer lips exceeds the total frictional resistance between the wire and the inner lips.

The one or more outer lips may be aligned substantially with the one or more inner lips.

A fine embossed pattern may be formed in a contact surface of the sealing plug with the inner surface of the cavity. Thus, a larger friction resistance can be obtained between the outer lips and the inner wall of the cavity.

The outer contact surface of the sealing plug with the cavity preferably is made of a material having a higher specific frictional resistance than the inner contact surface of the sealing plug with the wire.

The invention also relates to a watertight connector comprising a housing with at least one cavity into which the above-described sealing plug is insertable. A mirror finish preferably is applied to at least part of the inner wall of the cavity.

These and other objects, features and advantages of the present invention will become more apparent upon reading of the following detailed description of preferred embodiments and accompanying drawings. It should be understood that even though embodiments are separately described, single features thereof may be combined to additional embodiments.

### BRIEF DESCRIPTION OF THE DRAWINGS

FIG. 1 is a section of a rubber plug according to a first preferred embodiment of the invention.

FIG. 2 is a section showing the rubber plug in a cavity.

FIG. 3 is an enlarged section of the plug in the cavity.

FIG. 4 is a side view of a rubber plug according to a second preferred embodiment.

FIG. 5 is a section enlargedly showing a particular portion of a rubber plug according to a third preferred embodiment.

FIG. 6 is a side view of a prior art rubber plug.

### DETAILED DESCRIPTION OF THE PREFERRED EMBODIMENTS

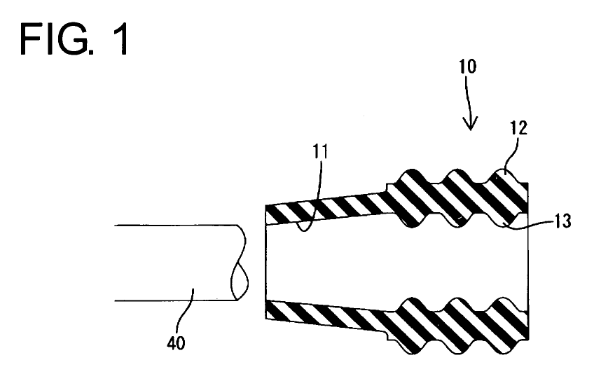

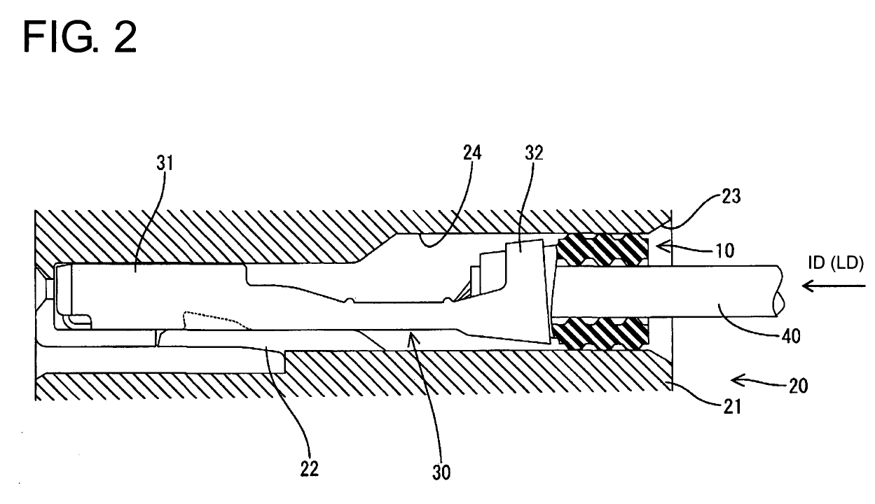

A first embodiment of a rubber plug according to the invention is identified by the numeral 10 in FIGS. 1 to 3. The rubber plug 10 is mounted in watertight connector 20 that has a housing 21 made e.g. of a synthetic resin. The housing 21 has at least one cavity 24 with a resin lock 22. A terminal insertion opening 23 is made at the rear end, which is the right end in FIG. 2. A female terminal fitting 30 is inserted into the cavity 24 and is locked by the resin lock 22. A mirror finish is applied to at least part of the inner wall of the cavity 24 for reducing surface roughness and for improving the sealing property of the rubber plug 10.

The terminal fitting 30 is inserted into the cavity 24 through the terminal insertion opening 23. As a result, the resin lock 22 engages a substantially box-shaped engaging portion 31 towards the front of the terminal fitting 30 for locking the terminal fitting 30 in the cavity 24. An unillustrated mating connector can be connected with the terminal fitting 30 so that a male tab of the mating connector is inserted into the box-shaped engaging portion 31 of the terminal fitting 30 to achieve electrical connection. A wire crimping portion 32 is formed at the rear end of the terminal fitting 30. The wire crimping portion 32 is crimped, bent or folded into connection with the front end of an insulated wire 40 and the front end of the rubber plug 10 mounted on the outer circumferential surface of the insulated wire 40 in a watertight manner. In this case, an overlap crimping method is utilized so that the wire crimping portion 32 is crimped to overlap and protect the rubber plug 10.

The rubber plug 10 preferably is made of a silicone or similar resilient material. A wire insertion hole 11 is formed inside the rubber plug 10 and extends substantially in forward and backward directions, as shown in FIG. 1. Circumferentially extending outer lips 12 are formed on the outer surface of the rubber plug 10 and are spaced apart along the insertion direction ID. Similarly, circumferentially extending inner lips 13 are formed on the inner surface of the wire insertion hole 11 and are spaced apart along the insertion direction ID. The outer lips 12 are at substantially the same longitudinal positions as the inner lips 13.

The outer diameter of the outer lips 12 is substantially larger than the inner diameter of the portion of the cavity 24 where the rubber plug 10 is to be positioned. Thus, the outer lips 12 are held in close contact with the inner wall of the cavity 24 and are compressed or deformed when the rubber plug 10 is inserted into the cavity 24. On the other hand, the inner diameter of the inner lips 13 is slightly smaller than or substantially equal to the outer diameter of the insulated wire 40. Thus, the outer lips 12 deform more than the inner lips 13 when the rubber plug 10 is inserted into the cavity 24, and a low frictional resistance is created between the inner lips 13 and the insulated wire 40. As a result, the insulated wire 40 can move relative to the rubber plug 10 due to expansion and elongation of the wire 40 in the longitudinal direction LD due, for example, to the influenced of heat.

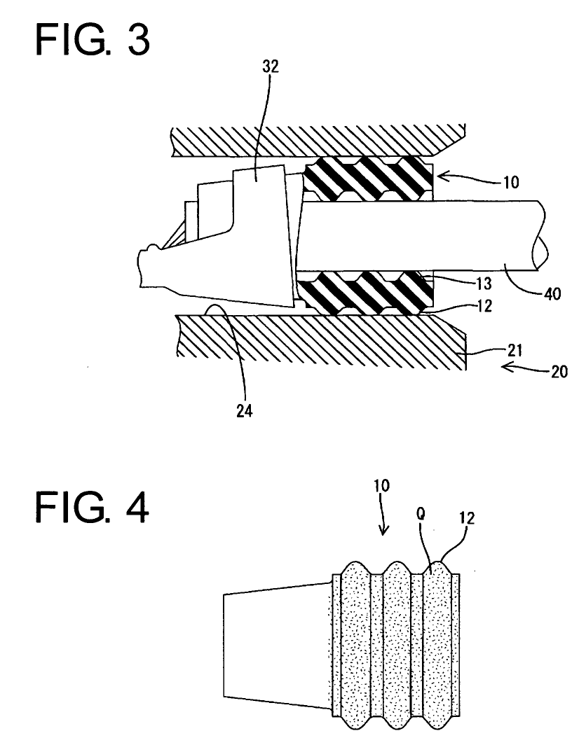

The insulated wire 40 is inserted along the insertion direction ID and is held in the wire insertion hole 11 of the rubber plug 10 and the wire crimping portion 32 is crimped into connection with the insulated wire 40 and the rubber plug 10. The rubber plug 10 in this state is fitted into the cavity 24 in the insertion direction ID, following the terminal fitting 30. The rubber plug 10 is inserted to a proper insertion position where the terminal fitting 30 is locked by the resin lock 22 to complete the insertion operation. In this state, the outer lips 12 are compressed and/or deformed while being held in close contact with the inner wall of the cavity 24 and the inner lips 13 are held substantially in close contact with the insulated wire 40 as shown in FIG. 3. As a result, a good sealability is displayed between the insulated wire 40 and the rubber plug 10 and between the rubber plug 10 and the cavity 24.

In the prior art, there is not a large difference between a total contact area of the outer lips 12 with the cavity 24 and a total contact area of the inner lips 13 with the insulated wire 40 since the degree of deformation of the outer lips 12 substantially equals the degree of deformation of the inner lips 13. However, in this embodiment, the total contact area of the outer lips 12 with the cavity 24 is considerably larger than the contact area of the inner lips 13 with the insulated wire 40 (preferably more than about 1.5 times larger, more preferably more than about two times, most preferably more than about three times). This difference in contact area is achieved by setting the degree of deformation or compression of the outer lips 12 to exceed the degree of deformation or compression of the inner lips 13. As a result, frictional resistance between the outer lips 12 and the cavity 24 exceeds the frictional resistance between the inner lips 13 and the insulated wire 40. Additionally, the resilient pressure exerted by the outer lips 12 on the inner wall of the cavity 24 may be larger that the resilient pressure of the inner lips 13 on the wire 40 so that the frictional resistance of the outer lips 12 is higher than the frictional resistance of the inner lips 13. It should be noted that the degree of deformation is a difference between a projecting height of the lips in a natural state and a projecting height when the lips are compressed in the cavity 24.

The watertight connector 20 may be exposed to a heat-cycle environment. Thus, a polyethylene resin of the insulation coating of the wire 40 expands in the longitudinal direction LD. As a result, the insulated wire 40 moves relative to the rubber plug 10 because the frictional resistance between the inner lips 13 and the insulated wire 40 is low. On the other hand, the outer lips 12 closely contact the inner wall of the cavity 24 during the movement of the insulated wire 40 because the frictional resistance between the outer lips 12 and the cavity 24 is high. As a result, the rubber plug 10 is prevented from coming out of the cavity 24, thereby ensuring a good sealing property.

FIG. 4 shows a second embodiment where a treatment is applied to the outer circumferential surface of the rubber plug 10 to increase the frictional resistance. More specifically, a surface treatment, such as embossing, is applied to at least parts of the outer lips 12 to be held in contact with the inner wall of the cavity 24. The surface treatment defines a fine embossed pattern Q comprising small protrusions. In this way, the frictional resistance between the outer lips 12 and the inner wall of the cavity 24 is increased to suppress movement of the rubber plug 10 in response to movement of the insulated wire 40. In this embodiment, the fine embossed pattern Q is made at substantially the entire outer circumferential surface of the rubber plug 10.

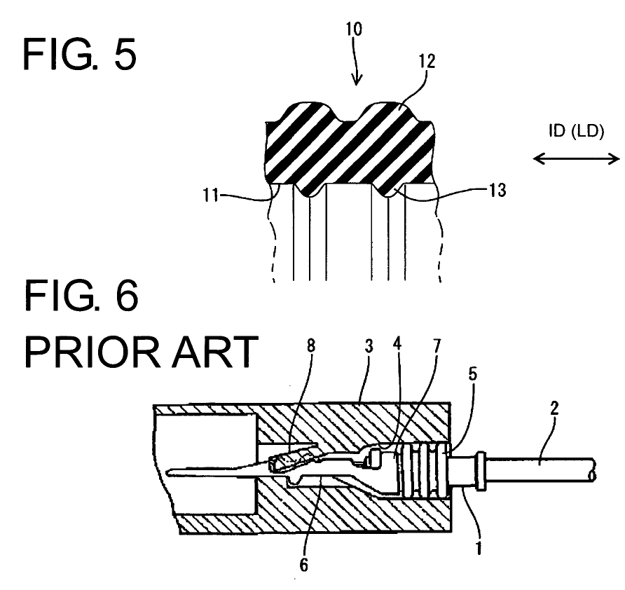

FIG. 5 shows a third embodiment where the outer lips 12 that contact the inner wall of the cavity 24 are elongated in the longitudinal direction LD to increase the contact area. However, the inner lips 13 that contact the insulated wire 40 are shortened in the longitudinal direction LD to reduce the contact area. Thus, the frictional resistance between the inner lips 13 and the insulated wire 40 is reduced while the frictional resistance between the outer lips 12 and the inner wall of the cavity 24 is increased.

The invention is not limited to the above described and illustrated embodiment. For example, the following embodiments are also embraced by the technical scope of the present invention as defined by the claims. Beside the following embodiments, various changes can be made without departing from the scope and spirit of the present invention as defined by the claims.

The rubber plug may be a block rubber plug formed with wire insertion holes for the respective insulated wires so that a plurality of insulated wires can be inserted therethrough.

The rubber plug may be formed in two colors of different materials at its inner and outer sides.

The rubber plug may be mounted on a male terminal fitting.

It should be understood that the frictional resistance created between the inner wall of the cavity 24 and the sealing plug 10 can be set larger than the frictional resistance created between the wire 40 and the sealing plug 10 by other means such as by providing more outer lips 12 than inner lips 13, by modifying the surface configuration of the inner and/or outer lips with suitable coatings, co-molding methods of other materials so that the material of the outer surface of the rubber plug differs from the inner surface.

What is claimed is:

1. A sealing plug (10) for a watertight connector (20), the sealing plug (10) being formed with at least one wire insertion hole (11) through which a wire (40) is to be inserted, and being at least partly insertable into a cavity (24) of a connector housing (21) to provide a watertight sealing between an inner wall of the cavity (24) and the wire (40), wherein:
a frictional resistance between the inner wall of the cavity (24) and the sealing plug (10) is larger than a frictional resistance between the wire (40) and the sealing plug (10), and
the frictional resistance between the wire (40) and the sealing plug (10) is set to permit a movement of the wire (40) relative to the sealing plug (10) when the wire (40) is caused to move.

2. The sealing plug (10) of claim 1, wherein at least one outer lip (12) is formed on an outer surface of the sealing plug (10) for contact with the inner wall of the cavity (24) and at least one inner lip (13) is formed on an inner surface of the sealing plug (10) for contact with the wire (40).

3. The sealing plug (10) of claim 2, wherein a degree of deformation of the outer lip (12) when the sealing plug (10) is inserted into the cavity (24) is larger than a degree of deformation of the inner lip (12).

4. The sealing plug of claim 3, wherein there are more of the outer lips (12) than the inner lips (13) so that a total frictional resistance between the inner wall of the cavity (24) and the outer lips (12) exceeds a total frictional resistance between the wire (40) and the inner lips (13).

5. The sealing plug of claim 2, wherein the outer lips (12) and the inner lips (13) are substantially aligned.

6. The sealing plug (10) of claim 1, wherein a fine embossed pattern (Q) is formed on at least part of a contact surface of the sealing plug (10) with the inner surface of the cavity (24).

7. The sealing plug (10) of claim 1, wherein an outer contact surface of the sealing plug (10) with the cavity (24) is made of a material having a higher specific frictional resistance than an inner contact surface of the sealing plug (10) with the wire (40).

8. A watertight connector (20) comprising a housing (21) having at least one cavity (24) into which a sealing plug (10) of claim 1 is insertable.

9. The watertight connector of claim 8, wherein a mirror finish is applied to at least part of the inner wall of the cavity (24).

10. The watertight connector of claim 8, wherein a terminal fitting (30) is connected to the wire (40) in overlapping relationship to the sealing plug (10).
